(19) United States
(12) Patent Application Publication
(10) Pub. No.: US 2024/0009902 A1
(43) Pub. Date: Jan. 11, 2024

(54) FILTER DEVICE

(71) Applicant: ENGEL AUSTRIA GmbH, Schwertberg (AT)

(72) Inventors: Guenther KLAMMER, Aschbach Markt (AT); Thomas KOEPPLMAYR, Marchtrenk (AT); Gerhard BAECK, Schwertberg (AT); Raffael Johannes RATHNER, Scharnstein (AT); Klaus FELLNER, Steyr (AT)

(21) Appl. No.: 18/219,823

(22) Filed: Jul. 10, 2023

(30) Foreign Application Priority Data
Jul. 11, 2022 (AT) A 50511/2022

(51) Int. Cl. B29C 45/24; B01D 27/08

(52) U.S. Cl. CPC B29C 45/24; B01D 27/08; B01D 2201/36

(57) ABSTRACT

A filter device for plasticized molding material includes a filter body and an adjusting body movable relative to the filter body between a first position and a second position. In the first position, a first flow path for the plasticized molding material is defined by channels in the filter body and in the adjusting body, and the first flow path is formed such that the plasticized molding material is filtered. In the second position, a second flow path for the plasticized molding material is defined by channels in the filter body and in the adjusting body, and the second flow path is formed such that the channels and/or a filter element are at least partially flushed and/or backflushed.

### BACKGROUND OF THE INVENTION

The present invention relates to a filter device for plasticized molding material, in particular plasticized plastic, a molding machine, a plasticizing unit, and/or an injection unit with such a filter device, as well as a method for operating a filter device.

The term molding machines can mean injection-molding machines, transfer-molding machines, presses and the like. Molding machines in which the plasticized compound is supplied to an open mold are also entirely conceivable. The state of the art is to be outlined below with reference to an injection-molding machine. This applies analogously to molding machines in general.

It is known from the state of the art to process impure plastics as molding material to be plasticized. These plastics can be e.g. recyclates, material to be ground or agglomerates, which are used for example in a recycling or compounding application.

This topic is becoming ever more important, wherein through the recycling of materials to be plasticized (for example thermoplastics) they can be supplied for a new use or a new area of application and thus a marked advantage is created with respect to environmental friendliness.

However, in order to supply such materials to be plasticized for an injection-molding process, it is necessary to purify them, wherein the impurities are to be removed from the material to be plasticized.

For this purification or prepurification of the materials to be plasticized, it is known that, in a first step, the impure material is plasticized by a continuously operating plasticizing unit and is then purified by degassing processes and filter systems.

After filtration and degassing, the plasticized material is cooled again and solidifies, wherein the purified material is usually brought directly into a form that is easy to process further, such as for example granules.

The granules produced from purified and degassed recycled material can then be used subsequently by an injection-molding process in an injection-molding machine.

However, a disadvantage of the known filter devices is that a filter cleaning is associated with a great deal of work, wherein the filter device—more precisely: the filter housing of the filter device—must be opened in order to make the filter element accessible and to be able to clean it of impurities or to replace it, after which the filter housing must then be closed again in order to prepare the filter device for the further process.

Specifically in the case of the use of recycled materials, wherein there is a greater contamination of the plasticized material, this results in very long downtimes, wherein the process has to be interrupted again and again in order to remove the impurities from the filter device.

This naturally has a negative effect on the productivity of the process, whereby the use of recycled materials is not made particularly attractive to a user.

Furthermore, a direct use in the injection-molding process is unappealing due to the long downtimes, as in particular in the case of the injection-molding process and the large quantities of material to be plasticized being processed there per unit of time this does not seem to be profitable.

### SUMMARY OF THE INVENTION

The object of the present invention is therefore to provide a filter device and a method for operating a filter device in which the disadvantages of the state of the art are at least in part improved and/or a more energy-efficient recycling of material to be plasticized can be implemented and/or a more energy-efficient purification of material to be plasticized is possible and/or a direct processing of material to be purified and plasticized is made possible and/or a more continuous, rapid or energy-saving possibility for filtering plasticized molding material is presented.

This object is achieved according to the invention by a filter device for plasticized molding material, in particular plasticized plastic, a molding machine, a plasticizing unit and/or an injection unit with such a filter device, as well as a method for operating a filter device.

According to the invention a filter device for plasticized molding material is provided, in particular plasticized plastic, with a filter body and an adjusting body movable relative to the filter body between a first position and a second position, wherein
in the first position of the adjusting body relative to the filter body a first flow path for the plasticized molding material is defined by channels in the filter body and in the adjusting body, wherein the first flow path is formed such that the plasticized molding material is filtered, and
in the second position of the adjusting body relative to the filter body a second flow path for the plasticized molding material is defined by channels in the filter body and in the adjusting body, wherein the second flow path is formed such that the channels and/or a filter element are at least partially flushed and/or backflushed.

The possibility is therefore created for flushing and/or backflushing a filter device automatically, efficiently and quickly in order to be able to clean the filter element very quickly when it is blocked by impurities.

Thus, it is now no longer necessary to open a filter housing laboriously by hand, for example by loosening screw connections, in order to reach a filter element.

Due to this quick and easy possibility for cleaning the filter device, the downtimes for filter cleaning can be drastically reduced, as a result of which the productivity and the energy efficiency can be increased.

The use of a recycled material is thus made much more attractive to a user, as a result of which the use of recycled materials can also be increased and a reduction in environmental impact can be achieved.

Furthermore, the possibility is created for quickly and effectively purifying plasticized molding material by the filter device before it is injected into a mold in the case of an injection-molding machine, wherein very large amounts of plasticized material can also be purified by the filter device, without having to accept long operational interruptions for cleaning the filter device, as a result of which a use of the filter device in the case of an injection-molding machine is made possible.

Such a use in the case of an injection-molding machine in turn makes it possible to supply recycled material directly to an injection-molding machine and makes a two-stage process for purification and subsequent further processing superfluous, as a result of which an advantage with respect to the energy efficiency is additionally created.

Through the filtering of the plasticized molding material directly in the molding process, the steps described at the beginning (such as for example the production of granules) can be omitted, which obviously represents a significant improvement in terms of complexity and economic efficiency.

A corresponding application of an embodiment of the present invention in the case of a recycling and/or compounding application can thus also be made considerably more attractive to a user, wherein the production costs and the production effort are minimized, whereby the environmental friendliness can be increased (through increased use).

As mentioned, a filter device according to the invention can also be used in already known embodiments of the state of the art, as described for example in the introduction to the description, and can be subsequently installed.

Molding machines can include injection-molding machines, transfer-molding machines, presses and the like. Molding machines in which the plasticized compound is supplied to an open mold are also entirely conceivable.

Within the meaning of the present document, by a filtration and/or a filtering of a plasticized molding material may be meant that foreign substances present in a plasticized molding material are, preferably mechanically, released, removed, discharged and/or separated at least partially from the plasticized molding material. This can thus also include separation methods.

Preferably, a further adjusting body is provided, which is movable relative to the filter body and to the adjusting body between a third position and a fourth position.

A third flow path for the plasticized molding material can be defined by channels in the adjusting body, in the filter body and in the further adjusting body in the fourth position, wherein the third flow path is formed such that the channels are at least partially flushed and/or backflushed and/or filtered molding material is filtered.

The first flow path and the second flow path can preferably be implemented in the third position of the further adjusting body.

Preferably, the adjusting body or the further adjusting body is connected to the filter body so as to be rotatable about an axis of rotation, wherein it is possible to change between the first position and the second position and/or the third position and the fourth position through a rotation of the adjusting body relative to the filter body.

Alternatively or additionally, the adjusting body and/or the further adjusting body are at least partially displaceable along a linear axis, wherein it is possible to change between the first position and the second position and/or the third position and the fourth position through a partial linear displacement of the adjusting body and/or of the further adjusting body relative to the filter body.

The adjusting body has at least two channels, preferably control contours, which are formed to divert the flow path differently in the case of a change between the first position and the second position, and/or wherein the further adjusting body has at least two channels, preferably control contours, which are formed to divert the flow path differently in the case of a change between the third position and the fourth position.

The at least two channels of the adjusting body and/or of the further adjusting body, preferably the control contours, can be formed for example by drilled holes in the adjusting body and/or the further adjusting body.

Preferably, the valve body has at least one filter component —preferably a plurality of filter components—which have several channels, as a result of which split flow paths through the filter device can be implemented.

A filter component can be formed for example by channels which have a correspondingly small dimension, with the result that impurities, solids and/or other contaminants can be filtered out of the plasticized molding material.

A size and/or a cross-sectional area of channels which are formed for the filtration of the plasticized molding material can, for example, be derived from the product requirements, wall thicknesses of the product or the smallest dimension of the cross section through which the plastic flows when the product is being produced.

Preferably, an area-equivalent circle cross-sectional area of channels which are formed for the filtration of the plasticized molding material has a maximum diameter of 1.5 mm.

Filter components which also contain porous materials which are suitable for the filtration of plasticized molding material are also conceivable.

The filter body has at least two filter components, wherein the at least two filter components are arranged concentrically one within the other and the channels are preferably formed at least partially between the at least two filter components.

At least—preferably precisely—one supply opening is provided for the plasticized molding material into the filter device and at least—preferably precisely—one discharge opening is provided out of the filter device, wherein the first flow path and the second flow path, and optionally the third flow path, lead from the at least one supply opening to the at least one discharge opening.

A design with a supply opening and a discharge opening has the particular advantage that an arrangement of the filter device in a system can be kept constant, with the result that the connectors of the filter device need not be released, and where necessary reconnected differently, for a backflushing and/or cleaning of the filter device, but rather this backflushing and/or cleaning can be carried out merely by internally adjusting the filter device, without having to make any structural alterations to the system.

Furthermore, protection is sought for a method for operating a filter device, in particular a filter device according to the invention, for plasticized molding material, in particular plasticized plastic, wherein
the plasticized molding material is filtered via channels and/or a filter element in a first position of an adjusting body relative to a filter body, and
the channels and/or the filter element in the adjusting body and/or in the filter body are at least partially flushed and/or backflushed in a second position of the adjusting body relative to the filter body.

### BRIEF DESCRIPTION OF THE DRAWINGS

Further advantages and details of the invention are revealed by the figures and the associated description of the figures, in which:

FIG. 1 is a longitudinal section through a first embodiment example of a filter device,

FIG. 2 shows the section marked in FIG. 1 through the embodiment example of FIG. 1,

FIG. 3 shows a filter component of the embodiment example of FIG. 1 in isolation,

FIG. 4 shows the detail marked in FIG. 3,

FIG. 5 shows a first flow path,

FIG. 6 shows a second flow path,

FIG. 7 shows a third flow path,

FIG. 8 shows an embodiment of a molding machine with a filter device, and

FIG. 9 shows a further embodiment of a molding machine with a filter device.

### DETAILED DESCRIPTION OF THE INVENTION

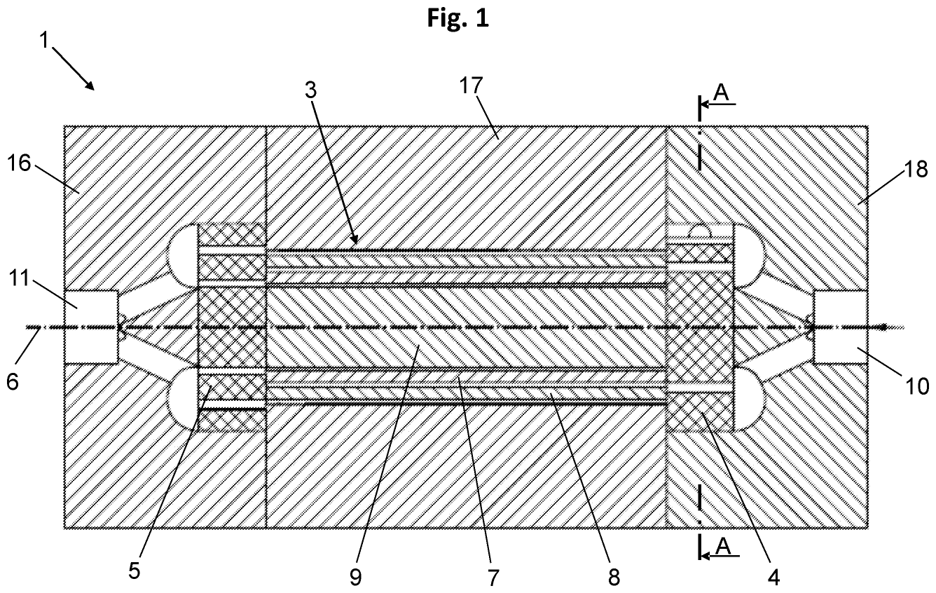

The embodiment example of FIG. 1 shows a longitudinal section through a filter device 1 along the axis of symmetry 6 of the filter device 1.

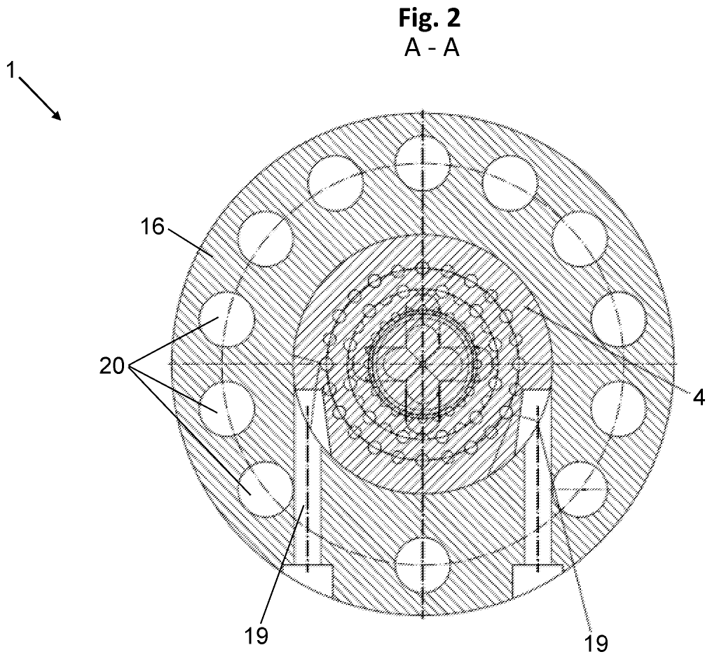

The section A-A marked in FIG. 1 is represented by FIG. 2.

The filter device 1 of FIG. 1 has a filter housing 17, which is closed via the two filter housing covers 16 and 18.

The filter housing covers 16, 18 are screwed to the filter housing 17 using screw connections (not represented for reasons of clarity).

These screw connections are located in the fastening holes 20 which lead through the filter housing covers 16, 18 and the filter housing 17.

The filter body 3 is arranged in the interior of the filter housing 17.

The filter body 3 of this embodiment example consists of several filter components 7, 8, 9, which are arranged concentrically to each other.

Channels 21, 22, 23 form between the filter components 7, 8, 9 through corresponding recesses in the filter components 7, 8, 9.

At the ends of the filter body 3 an adjusting body 4, 5 is arranged in each case, by which adjusting bodies 4, 5 a flow path of a plasticized molding material through the filter body 3 is defined.

The first filter housing cover 18 has a supply opening 10, via which plasticized molding material can be supplied to the filter device 1.

After the supply opening 10, the plasticized molding material is conducted to the adjusting body 4, which adjusting body 4 introduces the plasticized molding material into the filter body 3.

Once the plasticized molding material has passed through the filter body 3, the plasticized molding material reaches the further adjusting body 5, which conducts the plasticized molding material to the discharge opening 11 of the second filter housing cover 16 and thus discharges it from the filter device 1.

The adjusting bodies 4, 5 are mounted in the filter housing 17 so as to be rotatable about the axis of rotation 6.

As shown by FIG. 2, the filter housing cover 17 has actuator openings 19, whereby a rotational position of the adjusting body 4 can be changed or also secured via actuators engaging in the actuator openings 19.

Such actuators, which engage in the actuator openings 19, can for example be adjusting rods of a hydraulic or pneumatic actuator, or also merely bolts and/or screws engaging in the actuator opening 19.

The adjusting body can be moved between a first position 12 and a second position 13 by these actuators which engage in the actuator openings 19, wherein
in a first position 12 of the adjusting body 4 relative to the filter body 3 a first flow path 25 for the plasticized molding material is defined by channels 21, 23 in the filter body 3 and in the adjusting body 4, wherein the first flow path 25 is formed such that plasticized molding material is filtered, and
in a second position 13 of the adjusting body 4 relative to the filter body 3 a second flow path 26 for the plasticized molding material is defined by channels 21, 23 in the filter body 3 and in the adjusting body 4, wherein the second flow path 26 is formed such that the channels 21, 23 and/or a filter element 22 are at least partially flushed and/or backflushed.

The further adjusting body 5 can also be moved between a third position 14 and a fourth position 15 via the actuator openings 19, wherein a third flow path 27 of the plasticized molding material through the adjusting bodies 4, 5 and the filter body 3 can preferably be implemented.

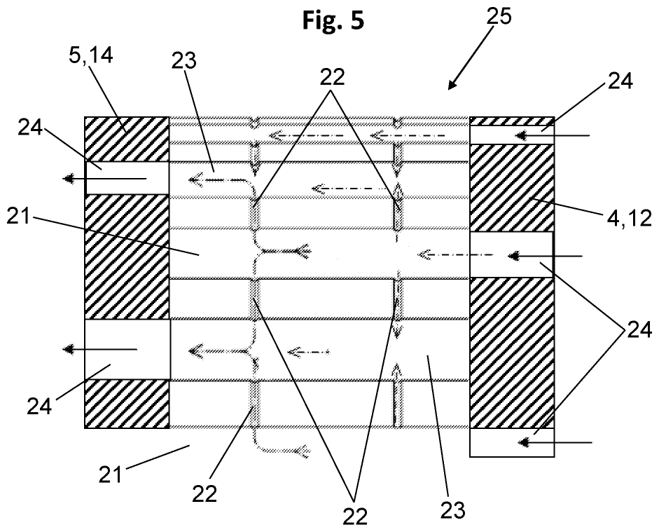

With respect to the explanation regarding the first flow path 25, the second flow path 26 and the third flow path 27, reference may be made to FIGS. 5 to 7.

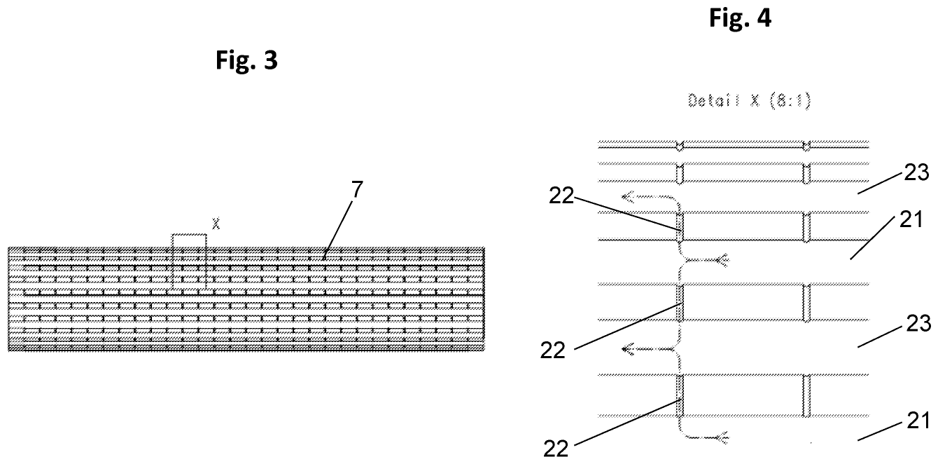

FIG. 3 shows the filter component 7 of the filter body 3 from FIG. 1 in isolation, wherein the detail X indicated in FIG. 3 is reproduced by FIG. 4.

Thus, a flow path (a first flow path 25) through the filter body 3
more precisely: the filter component 7—can be seen in FIG. 4, wherein via the adjusting body 4 the plasticized molding material is introduced into the (supply) channels 21, which are closed at an opposite end by the further adjusting body 5, with the result that plasticized molding material is pushed so as to be transferred into the (discharge) channels 23 via the (filter) channels 22, which serve as filter element.

Due to the geometrically small design of the (filter) channels 22 a filtration of the plasticized molding material occurs, wherein particles, impurities or suspended matter being carried in the plasticized molding material cannot pass through the (filter) channels 22 and thus remain in the (supply) channels 21.

However, it is also conceivable that in the case of a particular size and a particular pressure of the plasticized molding material and the impurities carried therein, these become deposited in the (filter) channels 22 or clog them up.

After passing through the (filter) channels 22, the filtered plasticized molding material is discharged from the filter device (for example by being squirted into the atmosphere) via the (discharge) channels 23 and the further adjusting body 4.

Such a first flow path 25 as just described is represented by FIG. 5.

Here, the adjusting body 4 is in a first position 12 in order to supply the plasticized molding material to the (supply) channels 21 of the filter body 3 via the control contours 24.

Since the (supply) channels 21 are sealed at an end facing away from the adjusting body 4 by the further (second) adjusting body 5, which is in a third position 14, the plasticized molding material is pushed via the (filter) channels 22, which serve as filter element, and reaches the (discharge) channels 23, via which the plasticized molding material can leave the filter body 3 via the further adjusting body 5 and its control contours 24.

If there is now too high a level of impurity and/or coating of the filter device 1, the (first) adjusting body 4 can be transferred into a second position 13.

A filter blocking or coating can be detected for example in that a characteristic signal is detected by a sensor system before and after the filter device 1 in the flow direction of the plasticized molding material.

An example sensor system for this purpose would be pressure sensors, wherein a signal characteristic of the filter coating and/or blocking can be detected via a pressure before the filter device 1 and a pressure after the filter device 1 in the flow direction of the plasticized molding material.

A pressure drop and/or pressure difference is preferably used here, wherein a flushing of the filter device 1 is carried out if the pressure drop and/or pressure difference becomes too large.

However, other sensors are also entirely conceivable, such as for example optical or rheological sensors or also temperature sensors.

It can for example also be provided that a control or regulating unit 28 is provided, which is formed to detect and monitor a signal characteristic of the filter coating and/or blocking.

The control or regulating unit 28 can be formed in order—when this characteristic signal reaches and/or exceeds a predefinable threshold value—to perform a backflushing or flushing of the filter device 1 by altering a position of the adjusting body 4 and/or of the further adjusting body 5 via actuators.

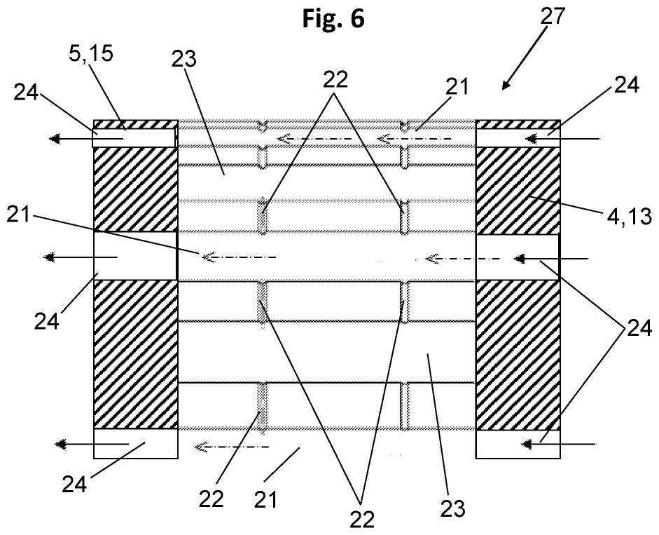

If the further adjusting body 5 is now transferred into a fourth position 14 while the adjusting body 4 is still in a first position 12 (as shown by FIG. 6) a third flow path 27 results.

The plasticized molding material can exit the filter body 3 again directly from the (supply) channels 21 through the third flow path 27, as a result of which by the direct through-flow of the (supply) channel 21 the (supply) channel 21 is flushed and deposited contaminants can be flushed out of the (supply) channel 21.

This contaminated plasticized molding material can then be flushed out of the system into the atmosphere at the filter device 1, or can for example be processed further into a molded part in a subsequent molding process, wherein the contaminated molded part can be taken out of the batch.

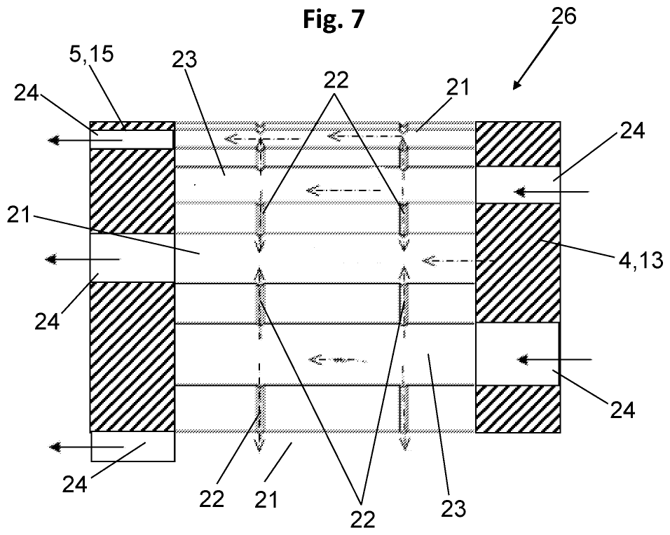

In a further step, the adjusting body 4 can now also be transferred from a first position 12 into a second position 13, whereby a second flow path 26 results, as represented by FIG. 7.

This has the result that plasticized molding material is first introduced into the (discharge) channels 23, is guided further from the (discharge) channels 23, via the (filter) channels 22, into the (supply) channels 21, from which (supply) channels 21 the plasticized molding material can leave the filter body 3 again via the further adjusting body 5.

Through such a procedure, as shown by FIG. 7, the filter body 3 is flushed entirely in a contrary direction compared with FIG. 5, wherein deposits and blockages can be flushed out of all the channels 21, 22, 23.

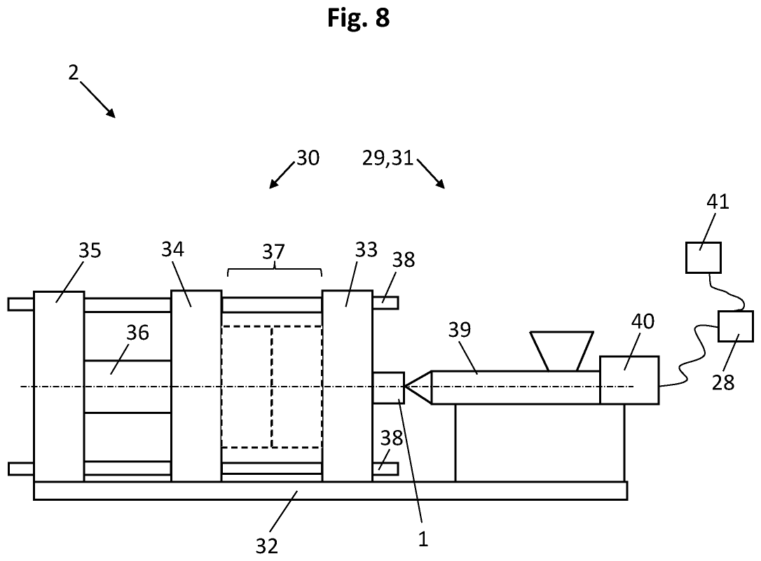

FIG. 8 shows a molding machine 2 with a filter device 1 according to an embodiment example of FIGS. 1 to 7.

The molding machine 2 represented by way of example in FIG. 8 is an injection-molding machine and has an injection unit 29 and a clamping unit 30, which are arranged together on a machine frame 32.

The machine frame 32 could alternatively also be formed multi-part.

The clamping unit 30 has a fixed platen 31, a movable platen 34 and an end plate 33.

The movable platen 34 is movable relative to the machine frame 29 via a symbolically represented drive 36 (for example a knuckle joint mechanism).

Mold halves of a mold 37 can be clamped or fitted (represented dashed) on the fixed platen 33 and the movable platen 34.

The fixed platen 33, the movable platen 34 and the end plate 35 are mounted and guided relative to each other by the rails 38.

The mold 37 represented closed in FIG. 8 has at least one cavity. An injection channel, via which a plasticized compound can be supplied to the plasticizing unit 31 leads to the cavity.

The injection unit 29 of this embodiment example has a barrel 39 and a plasticizing screw arranged in the barrel 39. This plasticizing screw is rotatable about an axis of rotation as well as movable axially along the axis of rotation in the conveying direction.

These movements are driven via a schematically represented drive unit 40. This drive unit 40 preferably comprises a rotary drive for the rotational movement and a linear drive for the axial injection movement.

The plasticizing unit 31 (and thus the injection unit 29) is in signaling connection with a control or regulating unit 28. Control commands are for example output to the plasticizing unit 31 and/or the drive unit 40 by the control or regulating unit 28.

The control or regulating unit 28 can be connected to an operating unit and/or a display device 41 or can be an integral constituent of such an operating unit.

It can be provided that the control or regulating unit 28 of the molding machine 2 at least partly undertakes the function of the control or regulating device 28 of the plasticizing unit 31, of the injection unit 29 and/or of the clamping unit 30, is formed as the latter, or alternatively even is implemented independently and/or separately from the latter.

In the case of a molding machine 2, as shown by FIG. 8, a filter device 1 according to an embodiment example of FIGS. 1 to 7 can be arranged between the injection unit 29 (and thus also the plasticizing unit 31) and the mold 37, wherein in each injection cycle the plasticized molding material is driven through the filter device 1 by the injection unit 29 and then introduced into the mold 37.

A molding machine 2 (injection-molding machine) as is represented by FIG. 8, the plasticizing and injection are implemented by a joint unit.

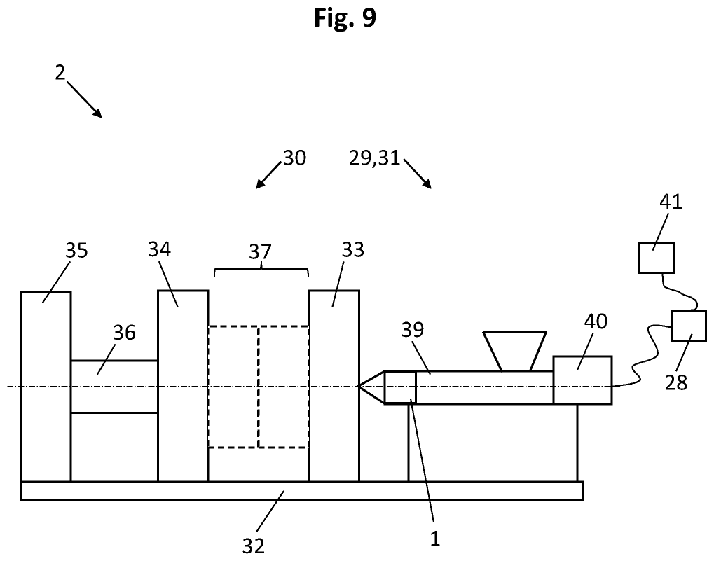

By contrast with the embodiment example of FIG. 8, the clamping unit 30 of FIG. 9 is formed without any rails.

Furthermore, in the embodiment example of FIG. 9 the filter device 1 is arranged in the barrel 39.

The remaining features of FIG. 9 substantially correspond to those of FIG. 8.

### LIST OF REFERENCE NUMBERS

1 filter device
2 molding machine
3 filter body
4 adjusting body
5 further adjusting body
6 axis of rotation
7 filter component
8 filter component
9 filter component
10 supply opening
11 discharge opening
12 first position of the adjusting body
13 second position of the adjusting body
14 third position of the second adjusting body
15 fourth position of the second adjusting body
16 filter housing cover
17 filter housing
18 filter housing cover
19 actuator openings
20 fastening opening
21 (supply) channel
22 (filter) channel/filter element
23 (discharge) channel
24 control contour
25 first flow path
26 second flow path
27 third flow path
28 control or regulating device
29 injection unit
30 clamping unit
31 plasticizing unit
32 machine frame
33 fixed platen
34 movable platen
35 end plate
36 drive
37 mold
38 rail
39 barrel
40 drive unit
41 operating unit and/or display device

1. A filter device for plasticized molding material, in particular plasticized plastic, with a filter body and an adjusting body movable relative to the filter body between a first position and a second position, wherein
in the first position of the adjusting body relative to the filter body a first flow path for the plasticized molding material is defined by channels in the filter body and in the adjusting body, wherein the first flow path is formed such that the plasticized molding material is filtered, and
in the second position of the adjusting body relative to the filter body a second flow path for the plasticized molding material is defined by channels in the filter body and in the adjusting body, wherein the second flow path is formed such that the channels and/or a filter element are at least partially flushed and/or backflushed.

2. The filter device according to claim 1, wherein a further adjusting body is provided, which is movable relative to the filter body and to the adjusting body between a third position and a fourth position.

3. The filter device according to claim 2, wherein a third flow path for the plasticized molding material is defined by channels in the adjusting body, in the filter body and in the further adjusting body in the fourth position, wherein the third flow path is formed such that the channels are at least partially flushed and/or backflushed and/or plasticized molding material is filtered.

4. The filter device according to claim 1, wherein the adjusting body and/or the further adjusting body are connected to the filter body so as to be rotatable about an axis of rotation, wherein it is possible to change between the first position and the second position and/or the third position and the fourth position through a rotation of the adjusting body relative to the filter body.

5. The filter device according to claim 1, wherein the adjusting body has at least two channels, preferably control contours, which are formed to divert the flow path differently in the case of a change between the first position and the second position, and/or wherein the further adjusting body has at least two channels, preferably control contours, which are formed to divert the flow path differently in the case of a change between the third position and the fourth position.

6. The filter device according to claim 1, wherein the filter body has at least one filter component—preferably a plurality of filter components—which has several channels, as a result of which split flow paths through the filter device can be implemented.

7. The filter device according to claim 1, wherein the filter body has at least two filter components, wherein the at least two filter components are arranged concentrically one within the other, and the channels are preferably formed at least partially between the at least two filter components.

8. The filter device according to claim 1, wherein at least—preferably precisely—one supply opening is provided for the plasticized molding material into the filter device and at least—preferably precisely—one discharge opening is provided out of the filter device, wherein the first flow path and the second flow path—and optionally the third flow path—lead from the at least one supply opening to the at least one discharge opening.

9. A plasticizing and/or injection unit with at least one barrel and arranged in the at least one barrel
a plasticizing screw and/or injection piston, preferably an injection screw, and
a filter device according to claim 1.

10. A molding machine, in particular injection-molding machine, with a filter device according to claim 1.

11. A method for operating a filter device, in particular a filter device according to claim 1, for plasticized molding material, in particular plasticized plastic, wherein
the plasticized molding material is filtered via channels and/or a filter element in a first position of an adjusting body relative to a filter body, and
the channels and/or the filter element in the adjusting body and/or in the filter body are at least partially flushed and/or backflushed in a second position of the adjusting body relative to the filter body.
